(19) United States
(12) Patent Application Publication
(10) Pub. No.: US 2012/0226817 A1
(43) Pub. Date: Sep. 6, 2012

(54) Methods for Transferring Media Sessions Between Local Networks Using an External Network Connected ue and Related Devices

(76) Inventors: Mikael Woxblom, Alvsjo (SE); Farjola Zaloshnja, Solna (SE); Olof Ermis, Stockholm (SE)

(21) Appl. No.: 13/503,135

(22) PCT Filed: Oct. 23, 2009
(86) PCT No.: PCT/SE2009/051213

§ 371 Date: Apr. 20, 2012

(51) Int. Cl. G06F 15/16

(52) U.S. Cl. 709/231

(57) ABSTRACT

An external network-connected UE is provided and configured to transfer a media session stream playing on a first local network-UE to start playing on the same position on a second local network-UE. The external network-connected UE is located outside each of the local networks and is configured to communicate with the virtual control nodes of the local networks, and via a media aggregating node, which all are configured to transfer the media session stream.

### TECHNICAL FIELD

The present invention relates to a method for a media aggregating node, for a virtual control node of a local network and for an external network-connected UE, of transferring an external network-media session stream from a first local network-UE to a second local-network UE, as well as to the media aggregating node, to the virtual control node of the local network, and to the external network-connectable UE.

### BACKGROUND

A local network, e.g. a home network or an office network, may comprise several connected consumer electronic devices, e.g.

personal computers, mobile phones, set-top-boxes and gaming consoles. Electronic devices within a local network can be adapted to communicate with each other e.g. according to DLNA (Digital Living Network Alliance) standard, which allows consumer electronic devices to communicate and share media content with each other, thereby enabling e.g. access of media files residing e.g. on a PC directly on a TV within the e.g. a DLNA home network, without a complicated configuration process.

A DLNA-compatible device is able to communicate with other DLNA-compatible devices within the DLNA network via the Universal Plug and Play (UPnP), which is a network protocol that is capable of establishing communication between DLNA-compatible devices within a DLNA network, without any configuration. By means of the UPnP, a DLNA device is able to e.g. discover and address other available DLNA devices within a DLNA network, and receive a description of their capabilities.

The DLNA-compatible devices within a DLNA network are typically of different types, based on their function in the media distribution and rendering, and the types involve a DMS (Digital Media Storage/Server), a DMP (Digital Media Player), a DMR (Digital Media Renderer), and a DMC (Digital Media Controller). A DMS may be e.g. a PC (Personal Computer) or a NAS (Network Attached Storage), and it is a device that stores media content and makes it available to a wired and/or wireless networked DMP or DMR. A DMP may be e.g. a TV, a stereo, a game console, or a mobile phone, and is a device that is able to find content on a

DMS, and provide playback and rendering capabilities. Further, a DMC is a device that locates content on a DMS and plays it on a DMR, and a DMC may be e.g. a PDA (Personal Digital Assistant) or a mobile phone. Finally, a DMR is a device that plays content received from a DMC and it may be a TV, an audio/video receiver, a video display or remote speakers.

FIG. 1 illustrates a conventional DLNA network comprising four DLNA compatible devices, i.e. a DMP 5a, a DMR 5b, a DMS 5c and a DMC 5d. The DMC (Digital Media Controller) 5d is able to obtain a file structure from the DMS, and send a specific URL to DMR, the URL received from DMS file structure. The DMR 5b is able to connect to the specified URL, which in this case is the DMS 5c itself. Further, the DMP 5d is also able to obtain a file structure from DMS, and play a link given in the DMS file structure.

Within a local network, e.g. such as the above-described DLNA home network, it is valuable for an end-user to be able to transfer a specific media session from a first device to a second device, e.g. from a PC located in the bedroom to a TV located in the living-room. A transfer of the media session from a first device to a second device may be followed by a termination of the media session on the first device, or result in that the media session is played on both the first device and on the second device simultaneously.

According to the conventional DLNA, a media session can not be transferred between different DLNA devices. Instead, if an end-user wishes to transfer a media session from a first DLNA-compatible device to a second DLNA-compatible device within a DLNA network, he/she starts playing the media session on the second device as a new media session, and terminates the playing of the media session on the first device. However, this conventional “transfer” has the drawback that the media session will be restarted and played from the beginning on the second device, instead of from the media session position on the first device, since no specific functionality is available for a user-friendly transfer of a media session from a first local network-device to a second local-network device.

Thus, it still presents a problem to enable an end-user to easily transfer a media session from a first device to a second device within the same local network, or between two different local networks of the same type, e.g. a DLNA network.

### SUMMARY

The object of the present invention is to address the problem outlined above, and this object and others are achieved by the method and the arrangement according to the appended independent claims, and by the embodiments according to the dependent claims.

According to one aspect, the invention provides a method for for a media aggregating node of transferring an external network-media session stream from a first local network-UE, to a user-selected second local network-UE. The transfer is controlled by an external network-connected UE located outside each local network and connected to the media aggregating node. Each local network comprises a virtual control node also connected to the media aggregating node, and the same user, or associated users, has to be logged-in to the external network-connected UE and to each virtual control node. The media aggregating node performs the following steps:
Sends requested information regarding local network-UEs to the external network-connected UE, the information received from the corresponding virtual control nodes;
Receives a command from the external network-connected UE to transfer the media session to a user-selected second local network-UE;
Obtains the position of the media session stream on the first local network-UE via the corresponding virtual control node;
Sends a command to the corresponding virtual control node to start playing the media session on the second local network-UE on said position.

The media aggregating node may check if an association exists between the logged-in users, and further perform the following additional steps:
Receives presence information from the corresponding virtual control node that said media session stream is played on said second local-network-UE;
Sends a command to the corresponding virtual control node to stop playing the media session stream on the first local network UE.

According to a second aspect, the invention provides a method for a virtual control node in a local network of transferring a media session stream from a first local network-UE to a user-selected second local network UE, and the transfer is controlled by an external network-connected UE located outside the local network. The external network-connected UE is connected to a media aggregating node, which is connected to the virtual control node, and the same user, or associated users, must be logged-in to the external network-connected UE and to the virtual control node. The virtual control node performs the following steps:
Obtains a requested position of the media session stream on said first local network-UE, and forwards to the media aggregating node;
Receives a command from the media aggregating node to start playing the media session on said position on a user-selected second local network UE;
Sends a corresponding local network-adapted play command to the second local network-UE.

The virtual control may perform the following additional steps:
Send information to the media aggregating node that said media session stream is played on said second local network-UE;
Receive a command from the media aggregating node to stop playing the media session stream on the first local network UE;
Send a corresponding local network-adapted stop command to the first local network-UE.

According to a third aspect, the invention provides a method for a virtual control node of a local network of the first local network-UE of transferring a media session stream from this first local network-UE to a user-selected second local network UE in a separate local network, and the transfer is controlled by an external network-connected UE located outside the local networks and connected to a media aggregating node. The media aggregating node is connected to the virtual control nodes of the local networks, and the same user, or associated users, must be logged-in to the external network-connected UE and to the virtual control nodes. The virtual control node performs the following step:
Obtains a requested position of the media session stream on said first local network-UE and forwards to the media aggregating node.

Also, the invention according to the third aspect provides a corresponding method for a virtual control node of the local network of said second local network-UE, and this virtual control node performs the following steps:
Receives a command from the media aggregating node to start playing the media session on the user-selected second local network UE, on the media stream position on the first local network-UE.
Sends a corresponding local network-adapted play command to the second local network-UE.

According to a fourth aspect, the invention provides a method for an external network-connected UE of transferring a media session stream from a first local network-UE to a user-selected second local network UE, and the external network-connected UE is located outside each local network and connected to a media aggregating node. Each local network comprises a virtual control node connected to said media aggregating node, and the same user, or associated users, must be logged-in to the external network-connected UE and to each of the virtual control nodes. The external network-connected UE performs the following steps:
Receives requested presence information regarding local network-UEs from the virtual control nodes, via the media aggregating node;
Sends a command to the media aggregating node to transfer the media session to a user-selected second local network-UE, by the media aggregating node obtaining the position of the media session stream on said first local network-UE via a corresponding virtual control node, and sending a command to a corresponding virtual control node to start playing the media session on the second local network UE on said obtained position.

According to a fifth aspect, the invention provides a media aggregating node arranged to transfer a media session stream from a first local network-UE to a user-selected second local network UE, and the transfer is controlled by an external network-connected UE located outside each local network, and connectable to the media aggregating node. The media aggregating node is further connectable to a virtual control node of each local network, and the same user, or associated users, must be logged-in to the external network-connected UE and to each virtual control node. The media aggregating node comprises:
A device for communicating with the external network-connectable UE, and the device is arranged to:

Send requested information regarding local network-UEs to the external network-connected UE;

Receive a command to transfer the media session stream to a user-selected second local network-UE;
A device for communicating with each virtual control node, and the device is arranged to:

Obtain the position of the media session stream on said first local network-UE from the corresponding virtual control node; Send a command to the corresponding virtual control node to start playing the media session stream on the second local network-UE on said position.

The media aggregating may further be arranged to store and remove associations between different users, and to check that a stored association exists between logged-in users.

According to a sixth aspect, the invention provides a virtual control node of a local network, arranged to transfer a media session stream from a first local network-UE to a user-selected second local network-UE, and the transfer is controlled by an external network-connected UE located outside each local network and connectable to a media aggregating node. The media aggregating node is connectable to each of the virtual control nodes, and the same user, or associated users, must be logged-in to the external network-connected UE and to each of the virtual control nodes, which comprises:
A device for communicating with the media aggregating node, and the device is arranged to:

Forward a requested position of the media session stream on said first local network-UE;

Receive a command to start playing the media session stream on a user-selected second local network UE, on said position, and
A device for communicating with the local network UEs,

And the device is arranged to:

Obtain the position of the media stream session from said first local network-UE;

Send a corresponding local-network adapted command to the second local network-UE to start playing the media session stream.

The local network of the virtual control node may comprise the first local network-UE and/or the second local network-UE.

According to a seventh aspect, the external network-connectable UE is arranged to transfer a media session stream from a first local network-UE to a user-selected second local network-UE from the outside of each local network, and the external network-connectable UE is connectable to a media aggregating node. The media aggregating node is connectable to a virtual control node of each local network, and the same user, or associated users, must be logged-in to said external network-connected UE and to each virtual control node. The external network-connectable UE comprises:
A device for communicating with a media aggregating node, and the device is arranged to:

Receive requested information regarding local network-UEs, wherein said information is forwarded from the corresponding virtual control node; and

Send a user-selected control command to transfer the media session to a user-selected second local network-UE.

The external network-connectable UE may further comprise:
A display for displaying the received information regarding media content and local network-UEs;
User input means.

The first local network-UE and the second local network-UE may bee located in the same local network or in separate local networks.

The local network may be a DLNA-network, and the local network-UEs may be DLNA-compatible. Further, the external network may be the Internet, and the external network-connected UE connected to the Internet.

An advantage with the present invention is that it enables an end-user to transfer a media session stream from a first local network-UE to the same position on a second local network-UE within the same local network, or located in two separate local networks, without having to restart the media session stream.

### BRIEF DESCRIPTION OF THE DRAWINGS

The present invention will now be described in more detail, and with reference to the accompanying drawings, in which:

FIG. 1 schematically illustrates a conventional DLNA network;

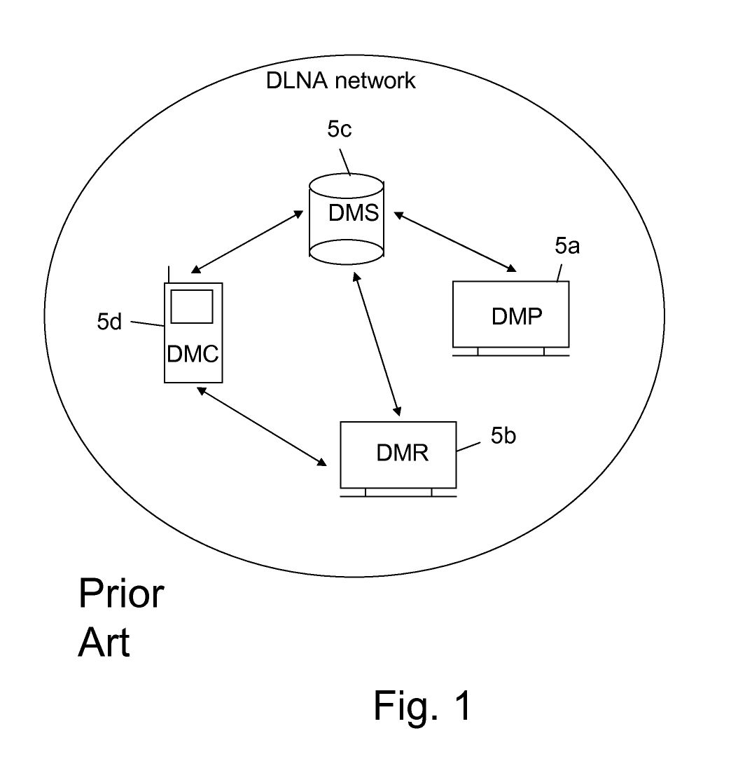

FIG. 2a is a block diagram schematically illustrating a local network, in particular a DLNA network, comprising a Virtual Control node, which is connected to a Media Aggregating node, and an external network-connected UE for transferring an external network-media content from a first DLNA-compatible device to a second DLNA-compatible device within the DLNA network, according to an exemplary embodiment of the invention;

FIG. 2b is a block diagram schematically illustrating two local networks, in particular DLNA networks, each comprising a Virtual Control node, which is connected to a Media Aggregating node, and an external network-connected UE for transferring an external network-media content from a first DLNA-compatible device in one of the local networks to a second DLNA-compatible device located in the other local network, according to an exemplary embodiment of the invention;

FIG. 3 is an exemplary signalling diagram illustrating how an Internet-connected UE starts playing Internet-media content on a first DLNA-compatible device within a DLNA network;

FIG. 4 is an exemplary signalling diagram illustrating the Internet-connected UE transferring the Internet-media content from said first DLNA-compatible device to a second DLNA-compatible device within the DLNA network;

FIG. 5 is a flow diagram showing an external network-connected UE transferring external network-media content from a first local network-UE to a second local network-UE;

FIG. 6 is a flow diagram showing the preceding steps when the external network-connected UE starts playing the content on said first local network-UE;

FIG. 7 is a flow diagram showing a media aggregating node transferring external network-media content from a first local network-UE to a second local network-UE;

FIG. 8 is a flow diagram showing the preceding steps when the media aggregating node starts playing the media content on the first local network-UE;

FIG. 9 is a flow diagram showing the steps performed by one virtual control node transferring external network-media content from a first local network-UE to a second local network-UE within the same local network, as well as the steps performed by the virtual control nodes of two separate local networks transferring external network-media content from a first local network-UE of one local network to a second local network-UE of the other local network;

FIG. 10 is a flow diagram showing the preceding steps when the virtual control node starts playing the media content on the first local network-UE;

FIG. 11 illustrated schematically an exemplary external-network-connectable UE, according to this invention;

FIG. 12a illustrated schematically an exemplary Media Aggregating node and an exemplary Virtual Control node, according to this invention; and

FIG. 12b illustrates an exemplary Media Aggregating node connected to two Virtual Control nodes of separate local networks, according to this invention.

### DETAILED DESCRIPTION

In the following description, the invention will be described in more detail with reference to certain embodiments and to accompanying drawings. For purposes of explanation and not limitation, specific details are set forth, such as particular scenarios, techniques, etc., in order to provide a thorough understanding of the present invention. However, it is apparent to one skilled in the art that the present invention may be practised in other embodiments that depart from these specific details.

Moreover, those skilled in the art will appreciate that the functions and means explained herein below may be implemented using software functioning in conjunction with a programmed microprocessor or general purpose computer, and/or using an application specific integrated circuit (ASIC). It will also be appreciated that while the current invention is primarily described in the form of methods and devices, the invention may also be embodied in a computer program product as well as in a system comprising a computer processor and a memory coupled to the processor, wherein the memory is encoded with one or more programs that may perform the functions disclosed herein.

In the following, the term local network-UE (User Equipment) is defined as a device that is capable of operating in a local network and communicating with the other devices in the local network, e.g. in a DLNA network. The term external network is defined as another network than the local network, and the term external network-connectable UE or external network-connected UE is defined as a device that is capable of communicating with this external network. According to a preferred embodiment of the invention, the external network corresponds to the Internet, but this invention is not limited thereto.

Conventionally, a DLNA network comprises one or more DMS (Digital Media Storage/Server) for storing media content, and the available media content can be presented to a user on a DMC (Digital Media Controller), typically in the form of tree structure. Thereafter, user-selected media content, such as video- or audio-media or an image, can be made available by the user to be played or rendered on a DMP (Digital Media Player) or on a DMR (Digital Media Renderer).

However, according to this invention, an external-network-connectable UE (User Equipment), such as e.g. an Internet-enabled mobile phone or a PC, is used for controlling and navigating media content within the local network (e.g. a DLNA network) via a media aggregating node, for pushing the media content directly to a first local network-compatible UE, e.g. to a DLNA-compatible PC, TV or radio, via a virtual control node of the local network, and transferring the media session to a second local network-compatible UE located in the same local network, or in a separate local network.

A user, or associated users, must be logged-in to the external network-connected UE and to the virtual control nodes of the local networks, and the term associated user is hereinafter defined to indicate an end-user logged-in with different userIDs, e.g. Joe.Smith@home and Joe.Smith@office, or different end-users, such as e.g. family members, logged in with different userIDs, e.g. Joe.Smith@home and Jill.Smith@home.

The end-user logs in to an external network-connectable UE and starts playing a selected media session on a first device of a local network, to which he, or an associated user, is logged-in via a virtual control node of the local network, by attaching the UE to a media aggregating node, and sending a play command selecting said first device and the media session to play. The media aggregating node authenticates the end-user and checks that he/she, or an associated user, is also logged in to the local network, and forwards the play-command to the device in the local network via the virtual control node. When the end-user wishes to transfer the ongoing media session to a second device, which is located in the same local network, or in another local network, to which the user, or an associated user, is also logged in via another virtual control node, he/she simply sends a transfer command from the external network-connectable UE selecting the second device, as well as the ongoing media session. The media aggregating node will obtain the position of the media session stream from the first device via the virtual control node of the local network of the first device, and send a command to the virtual control node of the local network of the second device to start playing the media session stream on the second device on said position. Thereby, the ongoing media session will be transferred from the first device to the second device, and continue playing on the second device from the position where it was transferred from the first device.

Said media aggregating node is responsible e.g. for authenticating users logged in to the UE and users logged in to the virtual control node of the local network, and the virtual control node controls and communicates with the local network-compatible devices of the local network. Further, the media aggregating node is able to store and remove associations between different users (i.e. UserIDs), and to check whether, or not, a stored association exists between users logged-in with different UserIDs. The external network-connectable UE communicates with the media aggregating node, which, in turn, communicates with the virtual control nodes of the local networks. Thereby, the external network-connectable UE is able to function as a custom-optimized navigation client, without the restrictions imposed e.g. by the DLNA and the UPnP. Further, the media files can be streamed on-demand to the local network-UEs, and do not have to be downloaded locally prior to playing.

In an exemplary use-case according to an embodiment of the present invention, according to which the local network is a DLNA network and the external network is the Internet, a user is logged in on an Internet-connected UE, such as e.g. a mobile phone or a PC. Thereafter, the user sends a request to the media aggregating node for information regarding e.g. available and popular radio news programs from a pre-selected Internet-media content provider. In response, the user receives a list comprising short descriptions, thumbnails and various additional metadata, provided by the Internet-media content provider via the content data-node and the media aggregating node. Further, upon request, the user receives a list of available and suitable devices within the available DLNA networks in return. This list is obtained by the virtual control nodes of the DLNA networks, and forwarded to the user via the media aggregating node. The user selects e.g. a DLNA-compatible radio located in the living room, and sends a play command to the media aggregating node indicating the selected news program and the selected radio in the living room. The media aggregating node forwards the play command via the virtual control node, conventionally as a UPnP SetAVTransport and UPnP Play to the selected device. When the device starts playing the news program, it will send a UPnP publish to inform the virtual control node of the start of the playing, to be forwarded to the media aggregating node.

Eventually, the user may choose to continue playing the media content on another device, which could be located in the same DLNA network, or in a separate DLNA network in which the same user, or an associated user, is also logged-in via the virtual control node, and he/she sends a transfer command to the media aggregating node, indicating the selected device. Upon receiving the transfer command, the media aggregating node send a message to the virtual control node to get the position of the media session playing on the first device, and the message is translated into a UPnP message by the virtual control node requesting the device to return the position to the virtual control node. Next, the media aggregating node receives the position from the virtual control node, and sends a play command to the same virtual control node, or to the virtual control node of a separate local network in which the second device is located, to start playing the media session on the user-selected second device, on the obtained position. The virtual control node issues suitable UPnP commands to start playing the media session stream on the second device, e.g. a UPnP SetAVTransport, a UPnP Play and a UPnP Seek, and when the second device has started playing the media session stream, it will return a UPnP publish to the virtual control node.

When the media aggregating node receives a publish from the virtual control node, it preferably sends a command to the (first) virtual control node to stop the first device to play the media session, to be forwarded as a UPnP command to the first device. Finally, when the first device has stopped playing, it will send another UPnP Publish to inform that the media session is terminated on the first device. However, in case the user indicated in the initial transfer command to the media aggregating node an intention to continue playing the media session stream on both the first and the second device simultaneously, the media aggregating node will not issue any stop command to the first device.

Thus, the present invention is implemented by means of a Media aggregating node (MA), one or two Virtual control nodes (VC), and of an external network-connectable UE, e.g. an Internet-connectable UE (IC UE), as described below:
A media aggregating node, e.g. a Media Aggregator, authenticates the users, processes all requests and presence messages, stores data, e.g. associations between different UserIDs, and makes the user profile available, as well as handles media and device metadata to be displayed on the external network-connected UE. The media aggregating node is able to communicate with the external network-connected UE, with the external network-media content providers via a content data sub-node, and with the virtual control nodes of one or more local networks, e.g. DLNA networks.
A virtual control-node is located within a local network and acts e.g. as a DMC (Digital Media Controller) in a DLNA network for communicating presence and control messages to the local network-compatible UEs within the local network. The virtual control node communicates with the UEs within the local network (e.g. according to the UPnP), and with the media aggregating node. According to an exemplary implementation, the virtual control node communicates with the media aggregating node via a Home Gateway, and could be co-located with the Home Gateway node.
An external network-connectable UE, e.g. a PC or a mobile phone, is capable of displaying available external network-media content and available and suitable local network-compatible UEs within the local network to a user, thereby enabling the user to select an external network-media content and an available local network-compatible UE, and send a control command, e.g. to start playing the selected media content on the selected local network
UE within the local network, and to transfer a media session to a selected second local network-UE within the same local network, or in another local network.

Other nodes that are involved in the implementation of the present invention are the following:
A content data-node owned by the Internet-media content providers, for publishing the available media titles and their respective URL's, by communicating with the media aggregating node.
A streaming server-node for providing a media stream to the local network-UEs.

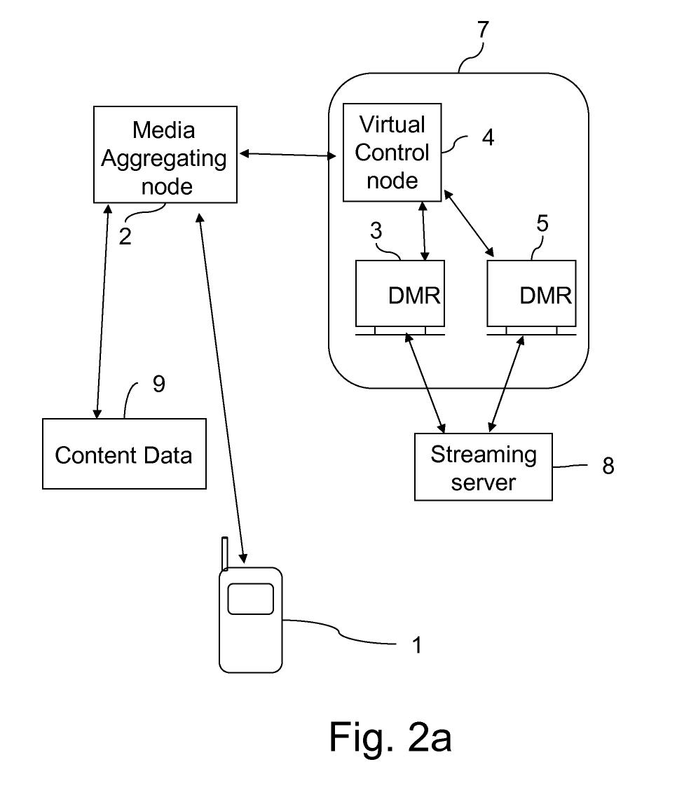

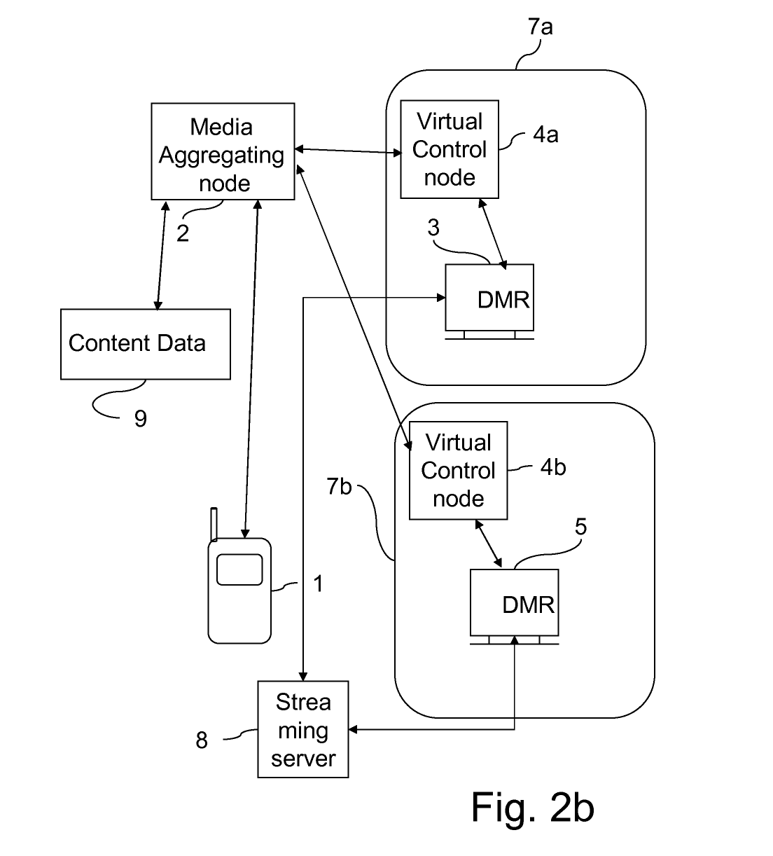

The above-described nodes are all illustrated in FIG. 2a, which is a block diagram schematically illustrating a DLNA network 7 comprising a Virtual Control node 4 and a first 3 and a second 5 DLNA-compatible UE, e.g. DMRs (Digital Media Renderers). The Virtual Control node is communicating with a Media Aggregating node 2, e.g. via a Home Gateway (not illustrated in the figure), and the Media Aggregating node is communicating with a Internet-connected UE 1 outside the DLNA network, and enabling the UE to control Internet media content in the DMRs within the DLNA, the media stream provided to the DMRs by a streaming server 8. The Media Aggregating node is further communicating with a content data-node 9 in order to obtain available media titles and their respective URLs.

FIG. 2b is a block diagram schematically illustrating two DLNA networks 7a, 7b, each comprising a Virtual Control node 4a, 4b, respectively, and a first 3 and a second 5 DLNA UE, e.g. DMRs (Digital Media Renderers). The Virtual Control nodes are both communicating with a Media Aggregating node 2, e.g. via a Home Gateway (not illustrated in the figure), and the Media Aggregating node is communicating with an Internet-connected UE 1 outside the DLNA networks, and enabling the UE to control Internet media content within the DLNA network, the media stream provided by a streaming server 8. The Media Aggregating node is further communicating with a content data-node 9 in order to obtain available media titles and their respective URLs.

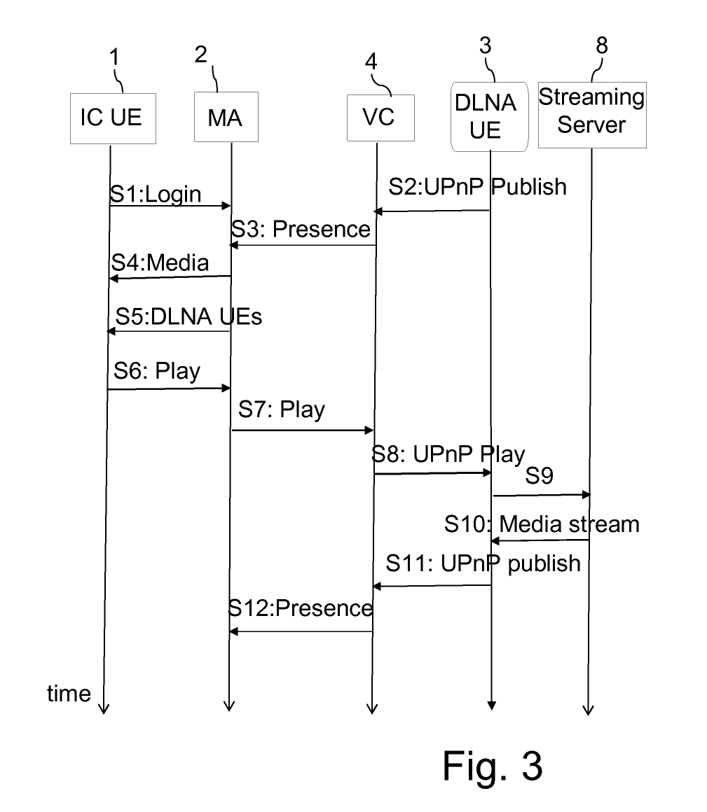

FIG. 3 is a signalling diagram illustrating how an Internet-connected UE 1 starts playing an Internet-media content in a DLNA UE 3, according to an exemplary embodiment of the invention.

In signal S1, the IC-UE 1 logs in to the MA 2 (media aggregating node) by sending user name and password. In signal S2, the DLNA UE sends a UPnP Publish to the VC 4 comprising presence information, e.g. that it is available. The VC, in turn, forwards the presence information to the MA, in signal S3. In signal S4, the MA sends information regarding Internet media content to the IC UE, after receiving a request from the IC UE, and the Internet media content-information has been obtained by the MA from a content-provider via a content data-node (not illustrated in the diagram). Further, in signal S5, the MA sends information regarding available and suitable DLNA UEs to the IC UE, after receiving a request, and further having determined that the logged-in user, or an associated user, is also logged in/registered in the VC.

Using the received information, the user is able to select an Internet media content and a DLNA UE, and to further select a control command to send to the MA, in signal S6, using the IC UE, the control command being e.g. a play-command. This play command is forwarded by the MA to the VC, in signal S7, and forwarded, in S8, e.g. as a corresponding UPnP Play command to the selected DLNA UE, i.e. a DMR. In the signals S9 and S10, the DLNA UE obtains the media stream associated with the selected Internet media content from the streaming server, and issues a UPnP Publish with the play status for the VC, in signal S11. The VC, in turn, forwards the updated presence information to the MA, in signal S12.

Thus, the media aggregating node 2 receives status and presence information from the local network-UEs of the local network via the virtual control nodes 4, 4a, 4b. When a user is logged in to an external network-connected UE 1 outside the local networks 7, 7a, 7b, the media aggregating node receives a user login from the external network-connected UE. The media aggregating node authenticates the user, and sends information regarding external network-media to the external network-connected UE, in response to a request. Further, it determines whether, or not, the user, or an associated user, is also logged in to a virtual control node, with which the media aggregating node is communicating. If so, the media aggregating node will send information regarding available and suitable local network-UEs to the external network-connected UE, typically in response to a request. When the media aggregating node receives a user-selected control command associated with a selected external network-media and a selected local network-UE from the external network-connected UE, it will forward the control command to the virtual control node.

Further, the virtual control nodes 4, 4a, 4b controls and communicates with the local network-compatible devices 3 and 5 of the local networks, 7, 7a, 7b, e.g. using the UPnP in case the local network is a DLNA network, and receives presence information to forward to the media aggregating node 2, which has authenticated the logged-in user. The virtual control node will receive a user-selected control command from the media aggregating node 2, e.g. a play command or a transfer command, the control command originating in the external network-connected UE 1 and associated with a user-selected external network-media content and with a user-selected local network-UE. The virtual control node will send a corresponding local network-adapted control command to the selected local network-UE, such that a received play-command associated with a selected media session and with a selected local network UE will cause said media session to be played on said local network UE.

Accordingly, the external network-connected UE 1 communicates with the media aggregating node 2, and sends user login information to the media aggregating node, and receives information regarding external network-media from the media aggregating node, in response to a request. In case the user, or an associated user, is also logged in to a virtual control node of a local network, the external network-connected UE will receive information regarding available and suitable local network-UEs from the media aggregating node, in response to a request, and this presence information is forwarded from said virtual control node. Next, the external network-connected UE will send a user-selected control command, e.g. a play command or a transfer command, which is associated with selected media content and with a selected local network-UE to the media aggregating node, to be forwarded to the virtual control node.

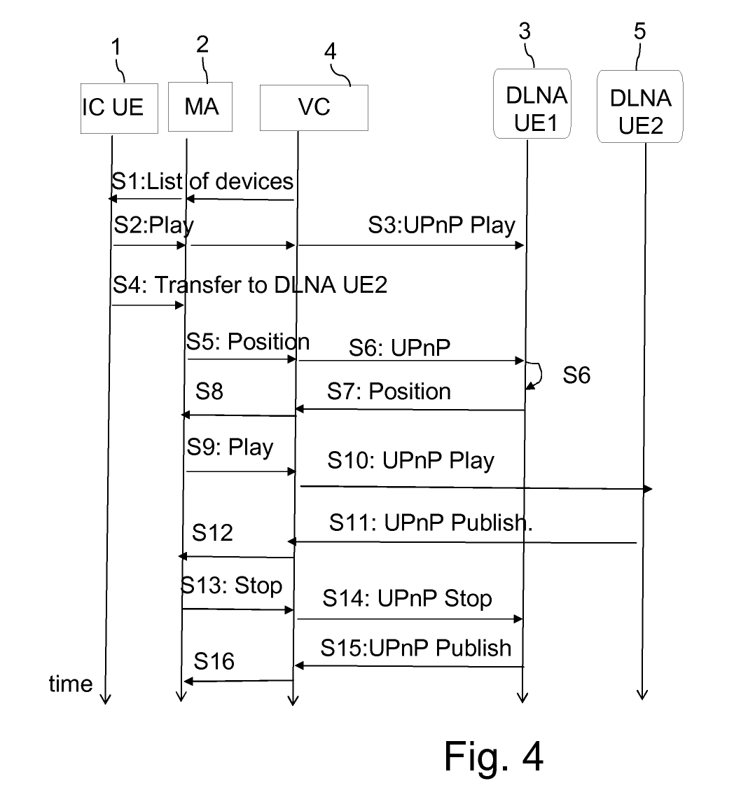

FIG. 4 is a signalling diagram illustrating how an Internet-connected UE transfers Internet-media content from a first DLNA UE (e.g. a DMR1) to a second DLNA UE (e.g. DMR2) within a DLNA network. In signal S1, the IC-UE 1 receives a (requested) list of available and suitable DLNA UE from the MA (e.g. in signal S5 illustrated in FIG. 3), and in signal S2, the user sends a command, using the IC UE, to play a certain media session on a selected DLNA UE1 to the VC via the MA. The play command is forwarded, in signal S3, as a corresponding UPnP Play command to the selected DLNA UE1, and the DLNA UE will return UPnP Publish indicating that it is playing (not illustrated in the figure.)

Next, in signal S4, the IC UE sends a command to the MA to transfer the media session to the second DLNA UE, i.e. DLNA UE2. The MA, in turn, asks the VC to obtain the position of the media session stream from DLNA UE1, in signal S5, and VC obtains the position in signals S6 and S7, and forwards to the MA, in signal S8. In signal S9, MA will send a command to VC to start playing the media session on DLNA UE2 on the obtained position, and the command is forwarded to DLNA UE2 in signal S10. After starting to play the session, the DLNA UE2 issues a UPnP Publish with the play status for the VC, in S11. The VC, in turn, forwards the updated presence information to the MA, in signal S12.

In signal S13, the MA sends a command to VC to stop playing the media stream, and the command is forwarded to DLNA UE1 in signal S14. The DLNA UE1 returns updated presence information in signal S15, which is forwarded to MA in signal S16.

According to another exemplary embodiment of the invention, the media session stream is transferred from a first device in a first local network, to a second device in a second local network. In this embodiment (not illustrated in FIG. 4), the DLNA UE1 communicates with the MA via a first virtual control node, VA1, and DLNA UE2 communicates with MA via a second virtual control node, VA2.

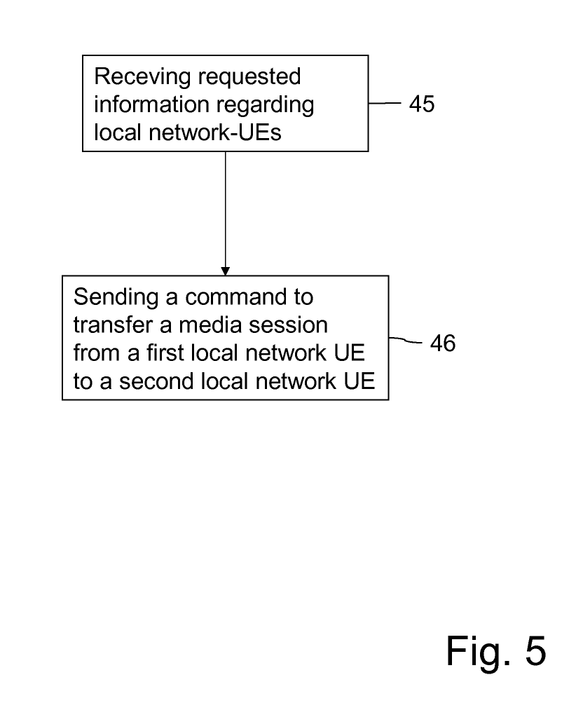

FIG. 5 is a flow diagram illustrating steps performed by an external network-connected UE in transferring a media session stream from a first local network-UE to a second local network

UE, the local network UEs located in the same or in separate local networks. In step 45, the external network-connected UE receives requested information regarding available and suitable local network-UEs from the corresponding virtual control nodes via the media aggregating node, and sends a command to the media aggregating node to transfer the media session stream to a user selected second local network-UE, which could be located in the same local network as the first local network-UE, or in another local network.

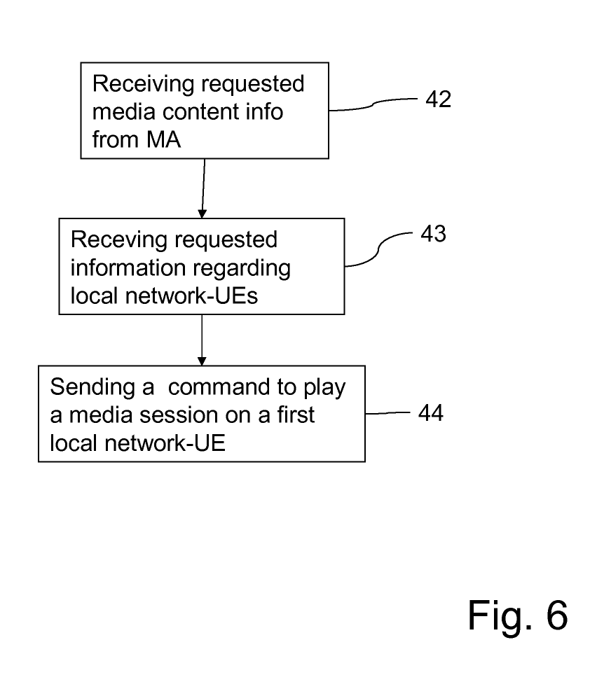

FIG. 6 is a flow diagram showing the preceding steps, when an external network-connected UE starts to play the external network-media content in the first local network UE by communicating with a media aggregating node. The external-network network connected UE sends login information to the media aggregating node, and will receive requested information regarding external network media content, in step 42. Next, the UE will receive requested information regarding local network-UEs from the media aggregating node, in step 43, e.g. a list of the local network-UEs that are available and suitable for a specific media content. Now, the external network-connected UE is able to send a user-selected control command to the media aggregating node, in step 44, to start playing a selected media session on a selected local network-UE.

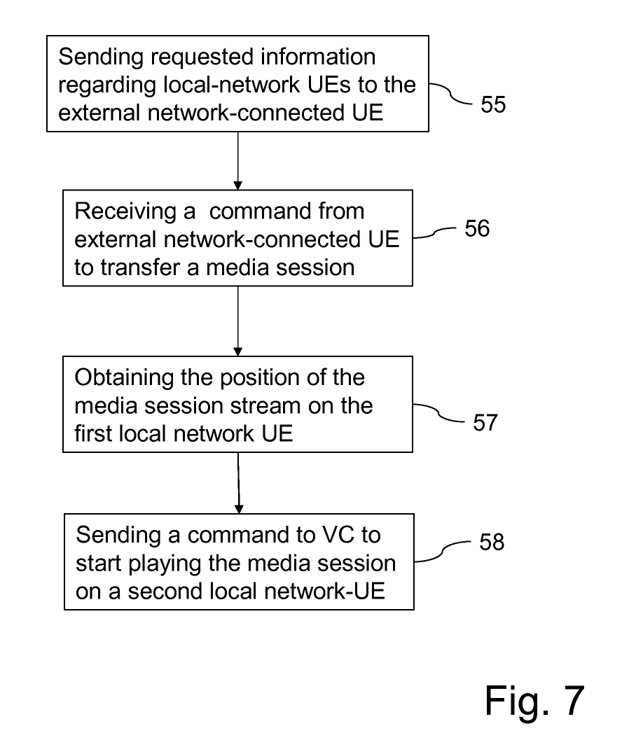

FIG. 7 is a flow diagram illustrating the steps performed by a media aggregating node in transferring a media session stream from a first local network-UE to a second local network UE, the local network UEs being located in the same or in separate local networks. In step 55, the media aggregating node sends requested information regarding available and suitable local network-UEs to the external network-connected UE, and receives a command from the external network-connected UE to transfer the media session stream to a user selected second local network-UE, in step 56. In step 57, the media aggregating node obtains the position of the media session stream on the first local network UE, by sending a request to the corresponding virtual control node to fetch and return the position. Next, in step 58, the media aggregating node sends a command to the corresponding virtual control node to start playing the media session stream on the user-selected second local network-UE, on the obtained position.

According to a further exemplary embodiment of the invention, the transfer command received from the external-network connected UE indicates that the media session stream shall be played only on the second local network-UE. Then the media aggregating node will send a command to the corresponding virtual control node to stop playing the media session stream on the first local network-UE, after receiving presence information from the corresponding virtual control node that the media session is being played on the second local network-UE.

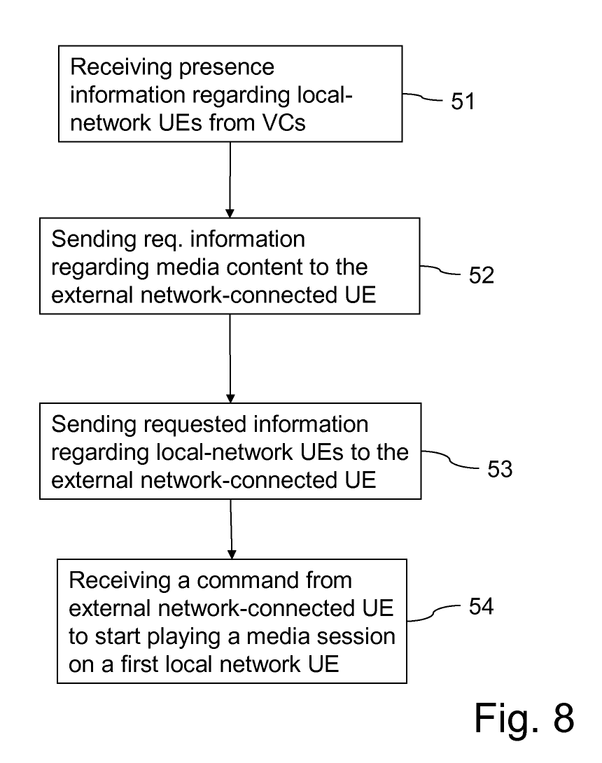

FIG. 8 is a flow diagram illustrating the preceding steps, how a media aggregating node starts playing the media session stream on the first local network-UE, by communication with a virtual control node of the local network, and with an external-network connected UE that is controlling the media content from the outside of the local network. In step 51, the media aggregating node receives presence information regarding local network-UEs from the corresponding virtual Control node. In step 52, a user login has been received form an external network-connected UE, and the media aggregating node sends information regarding external network media-content to the external network connected UE, after receiving a request. Further, the media aggregating node sends information regarding local network-UEs to the external network UE, in step 53, e.g. a list of local network-UEs that are available and suitable for playing a specific media content, after receiving a request, and after having determined that the logged-in user, or an associated user, is also logged-in to the local network. Finally, in step 54, the media aggregating node receives a play command from the external network-connected UE, selecting an external network media content, and the first local network-UE, and forwards the play command to the corresponding virtual control node.

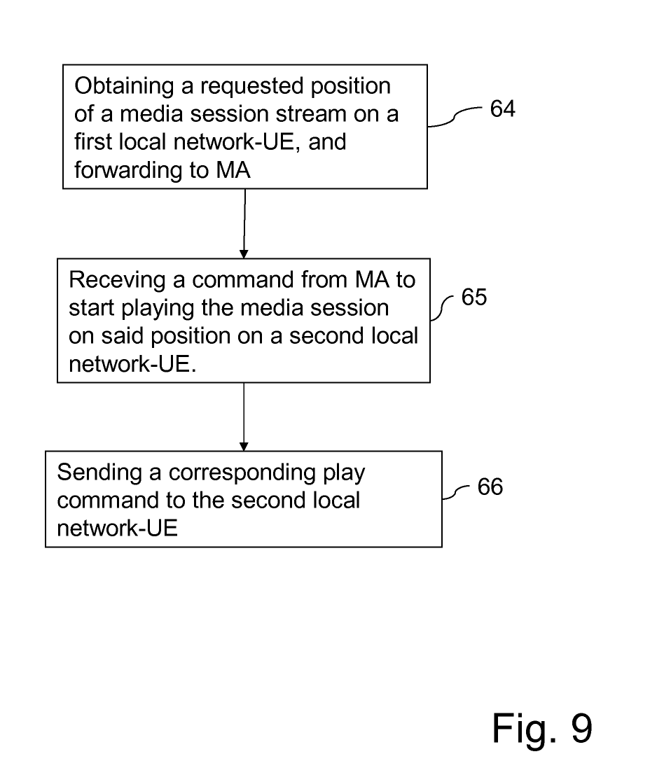

FIG. 9 is a flow diagram illustrating the steps performed by a virtual control node in transferring a media session stream from a first local network-UE to a second local network UE, the local network UEs located in the same local network. In case the first local network-UE and the second local network UE are located in separate local networks, being controlled by a first and a second virtual control node, respectively, the steps in FIG. 9 are performed alternating between the first and the second virtual control node, as indicated below.

In step 64, the (first) virtual control node obtains the position of the media session stream on the first local network-UE and forwards to the media aggregating node, in response to a request. Thereafter, the (second) virtual control node receives a command from the media aggregating node to start playing the media session stream on said position on the user-selected second local network-UE, in step 65, and sends a corresponding local network-adapted play command to the second local network-UE, in step 66.

Thus, in case the first and the second local network-UEs are located in the same local network, the steps in FIG. 9 are performed by the same virtual control node, i.e. the virtual control node of said local network. However, in case the local network-UEs are located in separate local networks, a first virtual control node performs step 64, and a second virtual control node performs the steps 65 and 66.

According to a further exemplary embodiment of the invention, the transfer command received from the external-network connected UE indicates that the media session stream shall be played only on the second local network-UE. Then the (first) virtual control node will receive a command from the media aggregating node to stop playing the media session stream on the first local network-UE, and send a corresponding local network-adapted command to the first local network-UE, e.g. as a UPnP, in case the local network is a DLNA network.

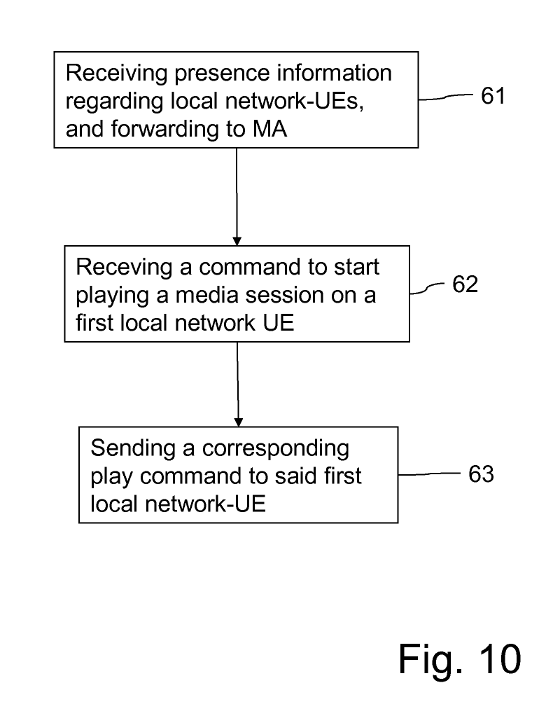

FIG. 10 is a flow diagram showing the preceding steps, when a virtual control node of a local network starts playing the external network-media session stream on the first local network-UE, by communicating with a media aggregating node and with the local network-UEs of the local network. In step 61, the virtual control node receives presence and status information from local network-UEs, and forwards the information to the media aggregating node. In step 62, the virtual control node receives a play command from the media aggregating node, the command originating in an external network-connected UE handled by a user that is also logged in to the virtual control node. Further, the play-command is associated with a user-selected external network-media content and with a user-selected local network-UE of the local network, i.e. the first local network UE. Next, in step 63, the virtual control node sends a corresponding local network-adapted control command to the selected local network-UE, e.g. a UPnP Play, in case the local network is a DLNA network.

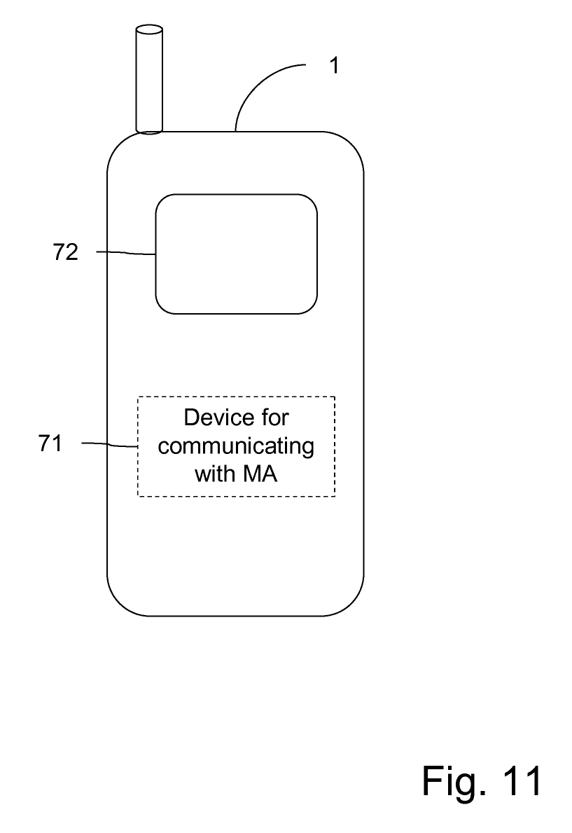

FIG. 11 illustrates schematically an exemplary external-network-connectable UE, according to this invention, e.g. a PC (Personal Computer) or a mobile phone, adapted to communicate with the external network, e.g. the Internet. The UE is provided with a device 71 for communicating with a media aggregating node, as well as with a display 72 for displaying available external network-media content and available local network-compatible UEs within the local network to a user in order to enable the user to select a media content and an available local network-UE. The UE is further provided with a suitable user input means (not illustrated in the figure) for initiating the UE to send log-in information and control commands to the media aggregating node, e.g. to start playing the selected media content on the selected local network UE.

The device 71 for communication with the media aggregating node further comprises a sender and a receiver, enabling the external network-connected UE to receive requested information regarding available and suitable local network-UEs from the corresponding virtual control nodes via the media aggregating node, and to send a command to the media aggregating node to transfer the media session stream to a user selected second local network-UE.

The sender is further arranged to send user login information to the media aggregating node, and to send a user-selected control command associated with user-selected external network-media and with a user-selected first local network-UE to the media aggregating node, e.g. to play a media content. The receiver is arranged to receive information regarding external network-media and available and suitable local network-UEs from the media aggregating node, in response to a request, wherein said information regarding local network-UEs is forwarded from a virtual control node, to which said user, or an associated user, is logged in.

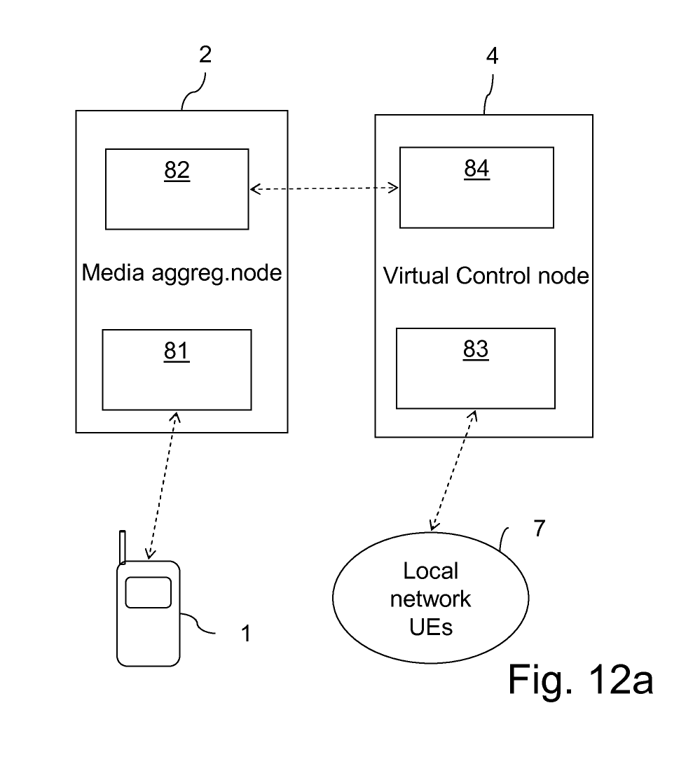

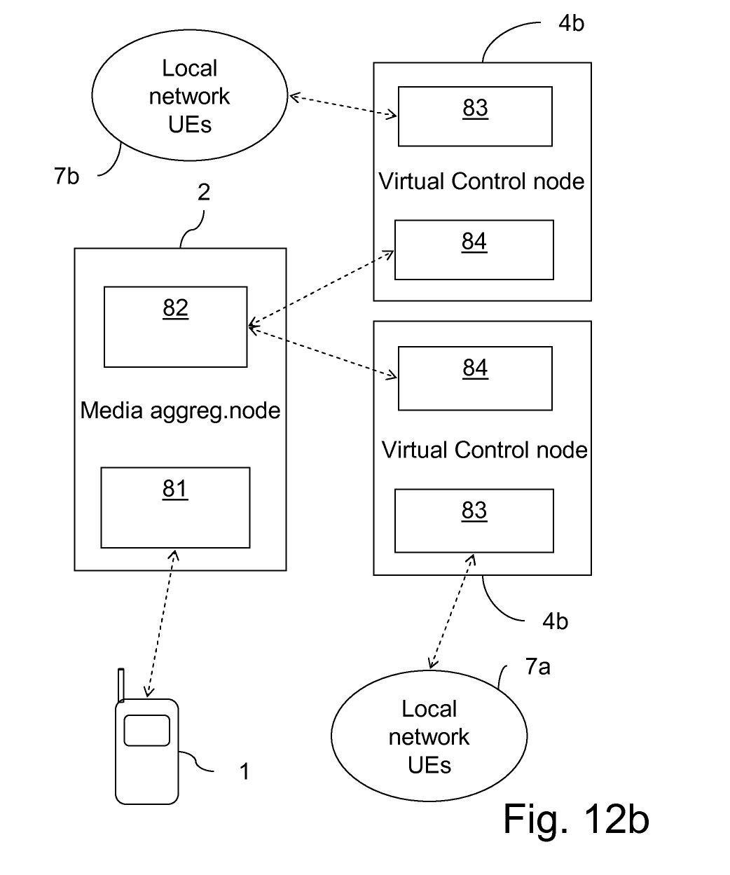

FIG. 12a illustrated schematically an exemplary Media Aggregating node 2 and an exemplary Virtual Control node 4, according to this invention.

As described previously, the media aggregating node 2 is responsible for authenticating the user, for processing all requests and presence messages, for storing data and making the user profile available, and for handling media and device metadata to be displayed on an external-network connected UE. The media aggregating node comprises a device 81 for communicating with the external network-connected UE 1, said device comprising a receiver arranged to receive e.g. a login from the user of an external network-connected UE, as well as a command to play a user-selected media content on a user selected first local network-UE, or to transfer the media session stream to a user selected second local network-UE. The device 81 also comprises a sender arranged to send e.g. information regarding external network-media and available and suitable local network-UEs to the user, in response to received requests.

The media aggregating node is further provided with a device 82 for communication with one or more virtual control nodes 4, 4a, 4b, said device comprising a receiver arranged to receive e.g. presence information regarding local network-UEs and the position of a media session stream on a local network-UE, and a sender arranged to forward messages, requests and commands to the appropriate virtual control node, e.g. to start or stop playing a media content.

The virtual control-node 4 act as a controller of the local network, e.g. as a DMC (Digital Media Controller) of a DLNA, for communicating e.g. presence messages and control commands with the UEs within the local network. The virtual control node is provided with a device 83 for communicating with the local network UEs, the device comprising a receiver arranged to receive presence information related to the local network UEs, and a sender arranged to forward local network-adapted commands to a selected local network UE, e.g. commands to start or stop playing a media session stream. The virtual control node is further provided with a device 84 for communicating with the media aggregating node 2, the device comprising a sender arranged forward e.g. received presence information, and a receiver arranged to receive e.g. commands, requests and messages.

FIG. 12b illustrated schematically an exemplary Media Aggregating node 2 connected to two Virtual Control nodes 4a, 4b, which belongs to separate local networks, 7a, 7b according to this invention. The media aggregating node comprises a device 81 provided with a sender and a receiver for communicating with the external network-connected UE 1, and a device 82 comprising suitable sender and receivers for communication with one or more virtual control nodes, as described above in connection with FIG. 12a.

The virtual control-nodes 4a, 4b are both provided with a device 83 comprising sender and receiver for communicating with the local network UEs of its local network 7a, 7b, as well as a device 84 comprising sender and receiver for communicating with the media aggregating node 2, as described above in connection with FIG. 12.

It should be noted that the external network-connectable UE 1, the Media Aggregating node 2 and the Virtual Control node 4, 4a, 4b, as illustrated in FIGS. 11, 12a and 12b, may be implemented by physical or logical entities using software functioning in conjunction with a programmed microprocessor or general purpose computer, and/or using an application specific integrated circuit (ASIC).

Further, the above mentioned and described embodiments are only given as examples and should not be limiting to the present invention. Other solutions, uses, objectives, and functions within the scope of the invention as claimed in the accompanying patent claims should be apparent for the person skilled in the art.

ABBREVIATIONS

DLNA Digital Living Network Alliance

DLNA UE DLNA-compatible User Equipment

DMC Digital/DLNA Media Controller

DMP Digital/DLNA Media Player

DMS Digital/DLNA Media Storage/Server

DMR Digital/DLNA Media Renderer

UPnP Universal Plug and Play

MA Media Aggregating node

VC Virtual Control node

IC UE Internet-connected User Equipment

1. A method for a media aggregating node of transferring a media session stream from a first local network-UE, to a user-selected second local network-UE, the transfer controlled by an Internet-connected UE located outside each local network and connected to the media aggregating node, each local network comprising a virtual control node also connected to the media aggregating node, wherein the same, or associated users, are logged-in to the Internet-connected UE and to each virtual control node, the method comprising:
sending requested information regarding local network-UEs to the Internet-connected UE, the information received from a corresponding virtual control nodes;
receiving a command from the Internet-connected UE to transfer the media session to a user-selected second local network-UE;
obtaining a position of the media session stream on the first local network-UE via the corresponding virtual control node; and
sending a command to the corresponding virtual control node to start playing the media session on the second local network-UE on the position.

2. The method of claim 1, wherein checks further comprising checking if an association exists between the logged-in users.

3. The method of claim 1 further comprising:
receiving presence information from the corresponding virtual control node that the media session stream is played on the second local-network-UE; and
sending a command to the corresponding virtual control node to stop playing the media session stream on the first local network UE.

4. The method of claim 1, wherein the first local network-UE and the second local network-UE are located in the same local network or in separate local networks.

5. A method for a virtual control node in a local network of transferring a media session stream from a first local network-UE to a user-selected second local network UE, the transfer controlled by an Internet-connected UE located outside the local network and connected to a media aggregating node, which is connected to the virtual control node, wherein the same user, or associated users, are logged-in to the Internet-connected UE and to the virtual control node, the method comprising:
obtaining a requested position of the media session stream on the first local network-UE;
forwarding the requested position to the media aggregating node; and
receiving a command from the media aggregating node to start playing the media session on the position on a user selected second local network UE;
sending a corresponding local network-adapted play command to the second local network-UE.

6. The method of claim 5, further comprising:
sending information to the media aggregating node that the media session stream is played on the second local network-UE;
receiving a command from the media aggregating node to stop playing the media session stream on the first local network UE; and
sending a corresponding local network-adapted stop command to the first local network-UE.

7. A method for a virtual control node in a local network of transferring an media session stream from a first local network-UE in the local network to a user-selected second local network UE in a separate local network, the transfer controlled by an Internet-connected UE located outside the local networks and connected to a media aggregating node, which is connected to the virtual control nodes of the local networks, wherein the user, or associated users, are logged-in to the Internet-connected UE and to the virtual control nodes, the method comprising
obtaining a requested position of the media session stream on said first local network-UE and forwarding to the media aggregating node.

8. A method for a virtual control node in a local network of transferring a media session stream from a first local network-UE in a separate local network to a user selected second local network UE of the local network, the transfer controlled by an Internet-connected UE located outside the local networks and connected to a media aggregating node, which is connected to the virtual control nodes of the local networks, wherein the user, or associated users, are logged-in to the Internet-connected UE and to the virtual control nodes, the method comprising:
receiving a command from the media aggregating node to start playing the media session on the user-selected second local network UE (5), on the media stream position on the first local network-UE (3); and
sending a corresponding local network-adapted play command to the second local network-UE.

9. The method of claim 5, wherein the local network is a DLNA-network, and the local network-UEs are DLNA-compatible.

10. A method for an Internet-connected UE of transferring a media session stream from a first local network-UE to a user-selected second local network UE, the Internet-connected UE located outside each local network and connected to a media aggregating node, each local network comprising a virtual control node connected to the media aggregating node, wherein the same user, or associated users, are logged-in to the Internet-connected UE and to each of the virtual control nodes, the method comprising:
receiving requested presence information regarding local network-UEs from the virtual control nodes, via the media aggregating node; and
sending a command to the media aggregating node to transfer the media session to a user-selected second local network-UE, by the media aggregating node obtaining the position of the media session stream on the first local network-UE via a corresponding virtual control node, and sending a command to a corresponding virtual control node to start playing the media session on the second local network UE on the obtained position.

11. The method of claim 10, wherein the first local network-UE and the second local network-UE are located in one of a same local network and separate local networks.

12. A media aggregating node arranged to transfer a media session stream from a first local network-UE to a userselected second local network UE, the transfer controlled by an Internet-connected UE located outside each local network and connectable to the media aggregating node, which is connectable to a virtual control node of each local network, wherein the user, or associated users, are logged-in to the Internet-connected UE and to each virtual control node, the media aggregating node comprising:
a device for communicating with the Internet-connected UE, the device configured to:
send requested information regarding local network-UEs to the Internet-connected UE; and
receive a command to transfer the media session stream to a user-selected second local network-UE; and
a device for communicating with each virtual control node, the device configured to:
obtain a position of the media session stream on the first local network-UE from the corresponding virtual control node; and
send a command to the corresponding virtual control node to start playing the media session stream on the second local network-UE on the position.

13. The media aggregating node of claim 12, further configured to store and remove associations between different users, and to check that a stored association exists between logged-in users.

14. The media aggregating node of claim 12, wherein the device for communicating with each virtual control node is further configured to:
receive presence information that the media session stream is played on the second local network-UE from the corresponding virtual control node; and
send a command to the corresponding virtual control node to stop playing the media session stream on the first local network-UE.

15. The media aggregating node according to of claim 12, wherein the first local network-UE and the second local network-UE are located in one of a same local network and separate local networks.

16. A virtual control node of a local network arranged configured to transfer a media session stream from a first local network-UE to a user-selected second local network-UE, the transfer controlled by an Internet-connected UE located outside each local network and connectable to a media aggregating node, which is connectable to each of the virtual control nodes, wherein the user, or associated users, are logged-in to the Internet-connected UE and to each of the virtual control nodes, the virtual control node comprising:
a device for communicating with the media aggregating node, the device configured to:
forward a requested position of the media session stream on the first local network-UE; and
receive a command to start playing the media session stream on a user-selected second local network UE, on the position, and
a device for communicating with the local network UEs, the device configured to:
obtain the position of the media stream session from the first local network-UE; and
send a corresponding local-network adapted command to the second local network-UE to start playing the media session stream.

17. The virtual control node of claim 16, wherein the device for communicating with the local network-UEs is further configured to:
receive presence information that the media session stream is played on the second local network-UE; and
forward a network-adapted command to stop playing the media session stream on the first local network UE; and in that the device for communication with the media aggregating node is further configured to:
receive the corresponding command to stop playing the media session stream on the first local network UE.

18. The virtual control node of claim 16, wherein the local network of the virtual control node comprises the first local network-UE and/or the second local network-UE.

19. The virtual control node in a local network, of claim 16, wherein the local network is a DLNA-network, and the local network-UEs are DLNA-compatible.

20. An Internet-connectable UE arranged to transfer a media session stream from a first local network-UE to a userselected second local network-UE from the outside of each local network, the Internet-connectable UE being connectable to a media aggregating node, which is connectable to a virtual control node of each local network, wherein the user, or associated users, are logged-in to the Internet-connectable UE and to each virtual control node, the Internet-connectable UE comprising:
a device for communicating with a media aggregating node, the device configured to:
receive requested information regarding local network-UEs, wherein the information is forwarded from the corresponding virtual control node; and
send a user-selected control command to transfer the media session to a user-selected second local network-UE.

21. The Internet-connectable UE of claim 20, further comprising:
a display for displaying the received information regarding media content and local network-UEs; and
user input means.

22. The Internet-connectable UE of claim 20, wherein the first local network-UE and the second local network-UE are located in one of a same local network and separate local networks.
